(19) United States
(12) Patent Application Publication
(10) Pub. No.: US 2024/0059318 A1
(43) Pub. Date: Feb. 22, 2024

(54) Using Connected Vehicles as Secondary Data Sources to Confirm Weather Data and Triggering Events

(71) Applicant: STATE FARM MUTUAL AUTOMOBILE INSURANCE COMPANY, Bloomington, IL (US)

(72) Inventors: Ryan Michael Gross, Normal, IL (US); M Eric Riley, SR., Heyworth, IL (US); Jody Ann Thoele, Bloomington, IL (US); Jordan Jeffers, Normal, IL (US); Shawn Renee Harbaugh, Normal, IL (US); Rick Lovings, Normal, IL (US); Joann C. Yant, Bloomington, IL (US); Jenny L. Jacobs, Normal, IL (US)

(21) Appl. No.: 17/979,729

(22) Filed: Nov. 2, 2022

Related U.S. Application Data
(60) Provisional application No. 63/410,394, filed on Sep. 27, 2022.
(60) Provisional application No. 63/402,717, filed on Aug. 31, 2022.
(60) Provisional application No. 63/399,045, filed on Aug. 18, 2022.

(51) Int. Cl. B60W 60/00; G07C 5/00

(52) U.S. Cl. CPC B60W 60/0015; G07C 5/008; B60W 2555/20

(57) ABSTRACT

Techniques for using connected vehicles as secondary data sources to confirm weather data and other triggering events are provided, including (1) determining indication of a weather event associated with a location of interest; (2) receiving indications of location data captured by location sensors associated with vehicles (such as vehicle-mounted sensors and/or mobile devices, virtual headsets, or wearables of passengers); (3) comparing the location data captured by the location sensors to a location of interest in order to identify one or more vehicles within a proximity of the location of interest; (4) receiving environmental sensor data captured by environmental sensors associated with one or more of the identified vehicles; and (5) determining, based upon the environmental sensor data captured by the environmental sensors associated with the one or more of the identified vehicles, an indication of an accuracy of the indication of the weather event associated with the location of interest.

### CROSS-REFERENCE TO RELATED APPLICATIONS

The present application claims priority to U.S. Provisional Patent App. No. 63/399,045, filed Aug. 18, 2022, and entitled “USING CONNECTED VEHICLES AS SECONDARY DATA SOURCES TO CONFIRM WEATHER DATA AND TRIGGERING EVENTS;” U.S. Provisional Patent App. No. 63/402,717, filed Aug. 31, 2022, and entitled “PREMIUM ADJUSTMENTS BASED UPON MITIGATION TECHNIQUES;” and U.S. Provisional Patent App. No. 63/410,394, filed Sep. 27, 2022, and entitled “USING CONNECTED VEHICLES AS SECONDARY DATA SOURCES TO CONFIRM WEATHER DATA AND TRIGGERING EVENTS;” the entire disclosures of each of which are incorporated by reference herein.

### FIELD OF THE DISCLOSURE

The present disclosure generally relates to technologies associated with autonomous and connected vehicles and, more particularly, to technologies for using autonomous and connected vehicles as secondary data sources to confirm weather data and other triggering events.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a parametric insurance policy, payouts are triggered by data that indicates whether a particular triggering event has occurred. In many cases, the triggering event may be a particular type of measured data exceeding a predetermined threshold value for that type of data. However, conventional techniques may be ineffective, inefficient, cumbersome, or have other drawbacks.

### SUMMARY

In a parametric insurance policy, payouts may be triggered by data that indicates whether a particular triggering event has occurred. In many cases, the triggering event may be a particular type of measured data exceeding a predetermined threshold value for that type of data. According to the present embodiments, a network of connected autonomous or otherwise “smart” vehicles equipped with a wide variety of sensors (including cameras) may be utilized to crowdsource the confirmation of policy-triggering events, such as specific weather events, weather measurements, or other natural events such as wildfires, earthquakes, etc. Additionally or alternatively, passengers riding within the autonomous or smart vehicles may also include or have on their persons mobile devices, wearables, virtual headsets (such as virtual reality headsets or augmented reality glasses), smart glasses, or other electronic or electrical components that may also include a wide variety of sensors (including cameras) that may be utilized to crowdsource the confirmation of policy-triggering events.

In one aspect, a computer-implemented method for using autonomous and connected vehicles as secondary data sources to confirm weather data and other triggering events is provided. The method may be implemented via one or more local or remote processors, transceivers, sensors, servers, vehicles, vehicle-mounted processors and sensors, mobile devices, wearables, virtual headsets (e.g., virtual reality headsets, smart glasses, augmented reality glasses, etc.), and/or other electronic or electric components. In one instance, the method may include (1) determining, by one or more processors, an indication of a weather event associated with a location of interest; (2) receiving, by the one or more processors, indications of location data captured by location sensors associated with each of a plurality of vehicles (for instance, the location sensors may be (i) vehicle-mounted sensors/cameras, and/or (ii) sensors/cameras associated with wearables, virtual headsets, or mobile devices associated with persons located within the vehicles, including the sensors/cameras discussed elsewhere herein); (3) comparing, by the one or more processors, the location data captured by the location sensors associated with each of the plurality of vehicles to a location of interest in order to identify one or more vehicles, of the plurality of vehicles, within a proximity of the location of interest; (4) receiving, by the one or more processors, environmental sensor data captured by environmental sensors associated with one or more of the identified vehicles; and/or (5) determining, by the one or more processors, based upon the environmental sensor data captured by the environmental sensors associated with the one or more of the identified vehicles, an indication of an accuracy of the indication of the weather event associated with the location of interest. The method may include additional, less, or alternate actions, including those discussed elsewhere herein.

In another aspect, a computer system for using autonomous and connected vehicles as secondary data sources to confirm weather data and other triggering events may be provided. The computer system may include one or more local or remote processors, transceivers, sensors, servers, vehicles, vehicle-mounted processors and sensors, mobile devices, wearables, virtual headsets (e.g., virtual reality headsets, smart glasses, augmented reality glasses, etc.), and/or other electronic or electric components. In one instance, the computer system may include one or more processors and a memory storing computer-executable instructions that, when executed by the one or more processors, cause the one or more processors to: (1) determine an indication of a weather event associated with a location of interest; (2) receive indications of location data captured by location sensors associated with each of a plurality of vehicles (for instance, the location sensors may be (i) vehicle-mounted sensors/cameras, and/or (ii) sensors/cameras associated with wearables, virtual headsets, or mobile devices associated with persons located within the vehicles, including the sensors/cameras discussed elsewhere herein); (3) compare the location data captured by the location sensors associated with each of the plurality of vehicles to a location of interest in order to identify one or more vehicles, of the plurality of vehicles, within a proximity of the location of interest; (4) receive environmental sensor data captured by environmental sensors associated with one or more of the identified vehicles; and/or (5) determine, based upon the environmental sensor data captured by the environmental sensors associated with the one or more of the identified vehicles, an indication of an accuracy of the indication of the weather event associated with the location of interest. The system may include additional, less, or alternate functionality, including that discussed elsewhere herein.

In still another aspect, a non-transitory computer-readable storage medium storing computer-readable instructions for using autonomous and connected vehicles as secondary data sources to confirm weather data and other triggering events may be provided. The computer-readable instructions, when executed by one or more processors, cause the one or more processors to: (1) determine an indication of a weather event associated with a location of interest; (2) receive indications of location data captured by location sensors associated with each of a plurality of vehicles (for instance, the location sensors may be (i) vehicle-mounted sensors/cameras, and/or (ii) sensors/cameras associated with wearables, virtual headsets, or mobile devices associated with persons located within the vehicles, including the sensors/cameras discussed elsewhere herein); (3) compare the location data captured by the location sensors associated with each of the plurality of vehicles to a location of interest in order to identify one or more vehicles, of the plurality of vehicles, within a proximity of the location of interest; (4) receive environmental sensor data captured by environmental sensors associated with one or more of the identified vehicles; and/or (5) determine, based upon the environmental sensor data captured by the environmental sensors associated with the one or more of the identified vehicles, an indication of an accuracy of the indication of the weather event associated with the location of interest. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts an exemplary computer system for using autonomous and connected vehicles as secondary data sources to confirm weather data and other triggering events, according to one embodiment;

FIG. 2 depicts a flow diagram of an exemplary computer-implemented method for using autonomous and connected vehicles as secondary data sources to confirm weather data and other triggering events according to one embodiment; and

FIG. 3 depicts an exemplary computing system in which the techniques described herein may be implemented, according to one embodiment.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

As discussed above, in a parametric insurance policy, payouts are triggered by data that indicates whether a particular triggering event has occurred. In many cases, the triggering event may be a particular type of measured data exceeding a predetermined threshold value for that type of data. According to the present embodiments, a network of connected autonomous or otherwise “smart” vehicles equipped with a wide variety of sensors (including cameras) may be utilized to crowdsource the confirmation of policy-triggering events, such as specific weather events, weather measurements, or other natural events such as wildfires, earthquakes, etc. Additionally or alternatively, passengers riding within the autonomous or smart vehicles may also include or have on their persons mobile devices, wearables, virtual headsets (such as virtual reality headsets or augmented reality glasses), smart glasses, or other electronic or electrical components that may also include a wide variety of sensors (including cameras) that may be utilized to crowdsource the confirmation of policy-triggering events.

For example, a vehicle that is located in a particular location (e.g., based upon GPS data from the vehicle) may utilize onboard sensors to directly or indirectly detect or measure weather conditions, such as an amount of rain or snow, an amount or size of hail, flood conditions, hurricane conditions, lightning conditions, tornado conditions, etc., or conditions related to other natural events such as wildfires, earthquakes, etc. Additionally or alternatively, sensors associated with driver or passenger mobile devices, virtual headsets, smart glasses, wearables, etc. may also be utilized to directly or indirectly detect or measure weather conditions. This data may be used to confirm that these weather conditions occurred at a location of interest (e.g., a location of an insured home or business, or another insured vehicle), at a hyper-local level.

That is, rather than relying solely on weather measurements (e.g., National Oceanic and Atmospheric Administration [NOAA] measurements) taken for the general vicinity of a location of interest at the state, city, or county level, the techniques provided herein involve checking such weather measurements against measurements originating from, or within, vehicles parked or travelling within (such as using data generated from vehicle-mounted sensors or sensors associated with driver or passenger mobile devices, virtual headsets, smart or augmented reality glasses, etc.) a threshold proximity of the location of interest. For instance, the threshold proximity may be a one-mile proximity, a half-mile proximity, a quarter-mile proximity, etc.

Advantageously, in some examples, the techniques provided herein can utilize measurements from vehicles (such as using data generated from vehicle-mounted sensors or sensors associated with driver or passenger mobile devices, virtual headsets, smart or augmented reality glasses, etc.) that are incidentally parked or travelling near locations of interest, allowing for the use of a rich field of environmental sensor data without requiring the permanent installation of environmental sensors near all possible locations of interest. In some examples, machine learning techniques may be used to predict/identify likely weather conditions or weather events that have occurred in locations of interest based upon measurements made by the connected vehicles.

### Exemplary System for Using Autonomous & Connected Vehicles as Secondary Data Sources to Confirm Weather Data & Other Triggering Events

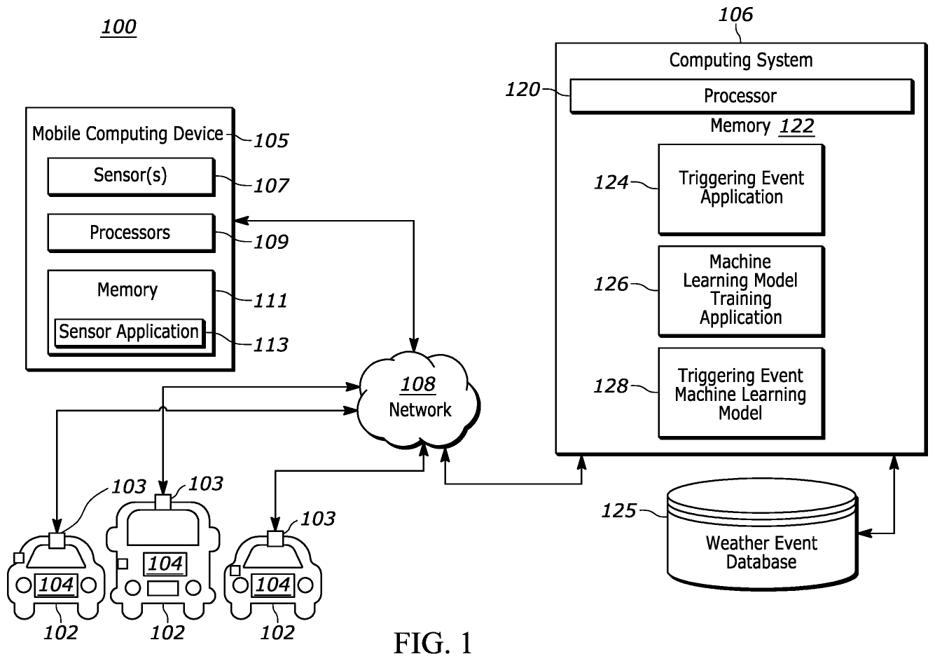

Referring now to the drawings, FIG. 1 depicts an exemplary computer system 100 for using autonomous and connected vehicles (and/or other computing devices within such vehicles) as secondary data sources to confirm weather data and other triggering events, according to one embodiment. The high-level architecture illustrated in FIG. 1 may include both hardware and software applications, as well as various data communications channels for communicating data between the various hardware and software components, as is described below.

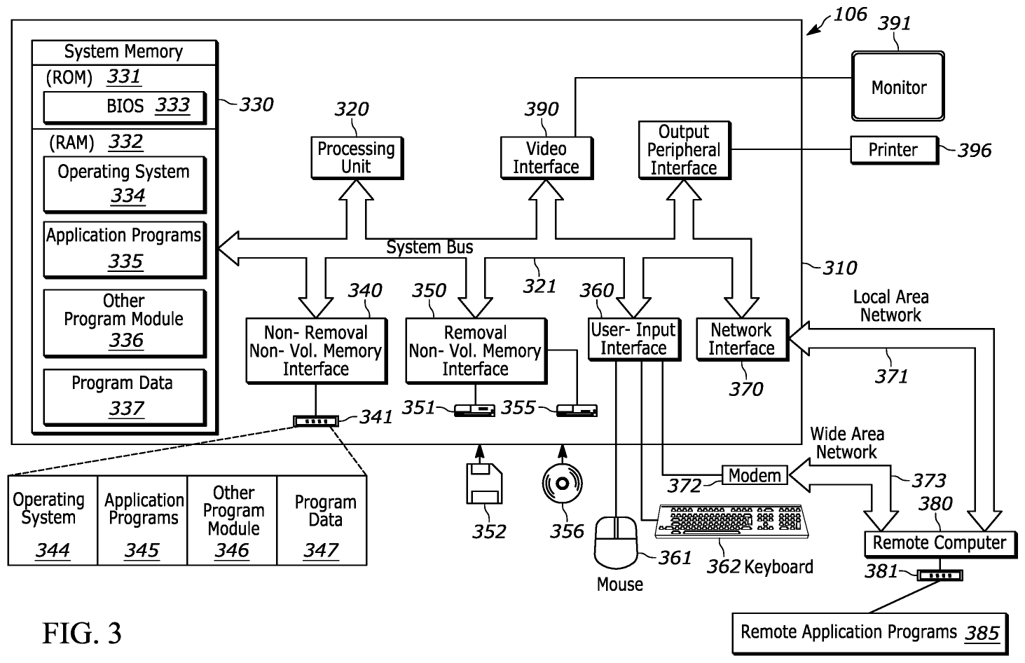

The system 100 may include a computing system 106, which is described in greater detail below with respect to FIG. 3, and one or more vehicle computing devices 103, associated with respective vehicles 102, as well as, in some cases, one or more mobile computing device 105 (which may include, e.g., smart phones, smart watches or fitness tracker devices, tablets, laptops, virtual reality headsets, smart or augmented reality glasses, wearables, etc.). The vehicles 102 may be autonomous vehicles, semi-autonomous vehicles, or connected manual vehicles, in various embodiments. In certain examples, in which the vehicles 102 are autonomous or semi-autonomous vehicles, the vehicle computing devices 103 may at least partially control the operation of the vehicles. The computing system 106, mobile computing device(s) 105, and the vehicle computing devices 103 may be configured to communicate with one another via a wired or wireless computer network 108.

Although one computing system 106, three vehicles 102, three vehicle computing devices 103, one mobile computing device 105, and one network 108 are shown in FIG. 1, any number of such computing systems 106, vehicles 102, vehicle computing devices 103, and networks 108 may be included in various embodiments. To facilitate such communications the vehicle computing devices 103 and mobile computing device(s) 105 may each respectively comprise a wireless transceiver to receive and transmit wireless communications to and from base stations, which then may be transmitted and/or received via computer network 108 to the computing system 106.

Each of the vehicle computing devices 103 may include, or may be configured to communicate with, one or more respective sensors 104 associated with respective vehicles 102. For instance, the sensors 104 may include onboard interior or exterior sensors. The sensors 104 may be configured to measure location data and environmental data associated with the vehicle, as well as, in some cases, vehicle operational data. For instance, the sensors may include cameras, microphones, noise level sensors, infrared or other heat sensors, light sensors (which may include solar cells), humidity sensors, wind sensors, precipitation detection sensors, temperature sensors, seismometers, gyrometers, accelerometers, magnetic sensors, lightning detection sensors, flood sensors, vibration sensors, snow depth sensors, hail detection sensors, smoke (or other gas detection) sensors, or any other sensors suitable for directly or indirectly detecting weather conditions such as an amount of rain or snow, a size of hail, lightning conditions, flood conditions, hurricane conditions, wind conditions, tornado conditions, blizzard conditions, ice storm conditions, or other natural conditions such as wildfires, earthquakes, etc.

Similarly, the mobile computing device(s) 105 may be associated with drivers and/or passengers of respective vehicles 102, and may include, or may be configured to communicate with, one or more respective sensors 107. As with the sensors 104, the sensors 107 may be configured to measure location data and environmental data associated with the vehicle, as well as, in some cases, vehicle operational data. For instance, the sensors 107 may include cameras, microphones, noise level sensors, infrared or other heat sensors, light sensors (which may include solar cells), humidity sensors, wind sensors, precipitation detection sensors, temperature sensors, seismometers, gyrometers, accelerometers, magnetic sensors, lightning detection sensors, flood sensors, vibration sensors, snow depth sensors, hail detection sensors, smoke (or other gas detection) sensors, or any other sensors suitable for directly or indirectly detecting weather conditions such as an amount of rain or snow, a size of hail, lightning conditions, flood conditions, hurricane conditions, wind conditions, tornado conditions, blizzard conditions, ice storm conditions, or other natural conditions such as wildfires, earthquakes, etc.

The mobile computing device(s) 105 may include one or more processor(s) 109, as well as one or more computer memories 111. Memories 111 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 111 may store an operating system (OS) (e.g., iOS, Microsoft Windows, Linux, UNIX, etc.) capable of facilitating the functionalities, apps, methods, or other software as discussed herein. Memorie(s) 111 may also store a sensor application 113. Executing the sensor application 113 may include sending data captured by the sensors 107 to the computing system 106, or to respective vehicle computing devices 103 which may in turn send the data captured by the sensors 107 to the computing system 106.

In some embodiments the computing system 106 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 120 (e.g., CPUs) as well as one or more computer memories 122.

Memories 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 122 may store an operating system (OS) (e.g., Microsoft Windows, Linux, UNIX, etc.) capable of facilitating the functionalities, apps, methods, or other software as discussed herein. Memorie(s) 122 may also store a triggering event application 124, a machine learning model training application 126, and/or a triggering event machine learning model 128.

Additionally, or alternatively, the memorie(s) 122 may store weather event data or other event data from various sources, such as from the National Oceanic and Atmospheric Administration (NOAA) or other weather authorities. The weather event data or other event data from the National Oceanic and Atmospheric Administration (NOAA) or other weather authorities may also be stored in a weather event database 125, which may be accessible or otherwise communicatively coupled to the computing system 106. In some embodiments, the weather event data or other vent data from various sources may be stored on one or more blockchains or distributed ledgers.

Executing the triggering event application 124 may include identifying a location of interest. For instance, the location of interest may be a location associated with an insured home, business, vehicle, etc. For instance, the location of interest may be a location associated with an insured home, business, or vehicle associated with an insurance claim, e.g., related to damage to the insured home, business or vehicle allegedly caused by a weather event or other natural event. Executing the triggering event application 124 may further include determining indications of weather events (or other natural events) that have occurred at the location of interest, e.g., based upon accessing weather event data or other natural event data from the National Oceanic and Atmospheric Administration (NOAA) or other weather authorities that is stored on the memor(ies) 122 and/or the weather event database 125. In some examples, the indications of the weather events (or other natural events) that have occurred at the location of interest may be associated with particular times or ranges of times.

Additionally, executing the triggering event application 124 may include receiving and/or retrieving indications of location data captured by the sensors 104 associated with the vehicles 102 (e.g., from the vehicle computing devices 103) and/or captured by the sensors 107 associated with the mobile computing devices 105 associated with the drivers and/or passengers of the vehicles 102. The location data may be compared to the location of interest to identify particular vehicles 102 that are within a threshold proximity of the location of interest (e.g., within one mile of the location of interest, within one half-mile of the location of interest, within one quarter-mile of the location of interest, etc.).

Moreover, in some examples, the location data captured by the sensors 104 associated with the vehicles 102 (and/or the captured by the sensors 107 associated with the mobile computing devices 105 associated with the drivers and/or passengers of the vehicles 102) may be time-stamped, and executing the triggering application 124 may include identifying particular vehicles 102 that were within the threshold proximity of the location of interest at particular times or during particular ranges of times associated with the indications of the weather events (or other natural events) that have occurred at the location of interest, according to the weather event data or other natural event data from the National Oceanic and Atmospheric Administration (NOAA) or other weather authorities.

Furthermore, executing the triggering event application 124 may include receiving and/or retrieving environmental sensor data (or other sensor data) captured by the sensors 104 associated with the identified vehicles 102 (and/or captured by the sensors 107 associated with the mobile computing devices 105 associated with the drivers and/or passengers of the vehicles 102) that are within the threshold proximity of the location of interest or that were within the threshold proximity of the location of interest at particular times or during particular ranges of times associated with the indications of the weather events (or other natural events) that have occurred at the location of interest, according to the weather event data or other natural event data from the National Oceanic and Atmospheric Administration (NOAA) or other weather authorities.

Moreover, executing the triggering event application 124 may include determining an indication of the accuracy of the indications of the weather events (or other natural events) that have occurred at the location of interest, according to the weather event data or other natural event data from the National Oceanic and Atmospheric Administration (NOAA) or other weather authorities. The triggering event application 124 may make this determination of accuracy based upon the environmental sensor data or other sensor data from the sensors 104 associated with the identified vehicles 102 (and/or the from the sensors 107 associated with the mobile computing devices 105 associated with the drivers and/or passengers of the vehicles 102).

In some examples, the triggering event application 124 may make this determination of accuracy directly based upon the environmental sensor data from the sensors 104 associated with the identified vehicles 102 (and/or from the sensors 107 associated with the mobile computing devices 105 associated with the drivers and/or passengers of the vehicles 102). For instance, a vehicle 102 may include various specialized sensors 104 specifically configured to detect hail, to measure rainfall, to measure snow depth, to detect lightning, etc., and data from these sensors 104 may be directly compared to weather event data from a weather authority to determine the accuracy of the weather event data from the weather authority. For example, if a weather authority indicated that there had been hail in a particular location at a particular time, and a specialized sensor 104 associated with a vehicle 102 in the particular location did not detect hail at the particular time, the triggering event application 124 may determine that the accuracy of the weather event data from the weather authority is lower than if the specialized sensor 104 associated with a vehicle 102 in the particular location did detect hail at the particular time.

Moreover, in some examples, the triggering event application 124 may determine the accuracy of the weather event data indirectly. For instance, in some examples, the triggering event application 124 may determine the accuracy of the weather event based on a partial or complete failure of certain sensors. For example, a video camera associated with an onboard safety system of an identified vehicle may return blurry images/videos, or may be unable to capture images/videos at all, during a severe storm, or due to intense snow or fog in the environment of the vehicle. Accordingly, the partial or complete failure of a video camera may be used to confirm that the storm, snow, fog, etc. in the particular location at the time the video capture was attempted. Additionally, in some examples, the triggering event application 124 may determine the accuracy of the weather event based on vehicle operational data indicative of a traffic slowdown that may have resulted from the weather event. For instance, sudden braking, slower cornering, or a sudden decrease in the acceleration of the identified vehicle 102 (or multiple identified vehicles 102) may indicate that the identified vehicle 102 is slowing down due to a weather event that affects the safety of the road in the immediate area of the vehicle 102, or due to a weather event that affects the safety of the road further ahead such that traffic resulting from the weather event slows down the pace of the vehicle 102. In some examples, a traffic flow model may be used to pinpoint a location associated with a weather event that is causing increased traffic for the identified vehicles 102. In some examples, the severity of the stop or slowdown of traffic for the identified vehicles 102 can be an indication of the severity of the weather event that may be causing the stop or slowdown of traffic. That is, in some examples, a more severe storm or other weather event may result in more stopped vehicles, while a less severe storm or other event may result in a traffic slowdown without actual stopping. As another example, the triggering event application 124 may indirectly determine whether a lightning strike has occurred based upon data from a noise level sensor alone. Additionally, the triggering event application 124 may determine the accuracy of the weather event data indirectly based upon multiple types of environmental sensor data from the sensors 104 associated with the identified vehicles 102 (and/or from the sensors 107 associated with the mobile computing devices 105 associated with the drivers and/or passengers of the vehicles 102). For example, the triggering event application 124 may determine whether a lightning strike has occurred based upon a combination of data from temperature sensors, humidity sensors, noise level sensors, and/or electricity or magnetism sensors.

In some cases, the triggering event application 124 may use sensor data from multiple types of sensors 104 associated with one identified vehicle 102 (and/or from multiple sensors 107 associated with one mobile computing device 105 associated with a driver and/or passenger of a vehicle 102) to determine the accuracy of the weather event data. For instance, one of the identified vehicles 102 may include sensors 104 such as temperature sensors, humidity sensors, noise level sensors, and/or electricity or magnetism sensors and the triggering event application 124 may use some combination of data from these various sensors to identify locations and/or timing of lightning strikes.

Alternatively, one of the identified vehicles 102 within a threshold proximity of the location of interest may include a temperature sensor, while another of the identified vehicles 102 within a threshold proximity of the location of interest may include a humidity sensor, while another of the identified vehicles 102 within a threshold proximity of the location of interest may include a noise level sensor, and another of the identified vehicles 102 within a threshold proximity of the location of interest may include an electricity and/or magnetism sensor, etc., and the triggering event application 124 may use some combination of data from these various sensors 104 from different vehicles 102 (and/or from the sensors 107 associated with the mobile computing devices 105 associated with the drivers and/or passengers of the different vehicles 102) to identify locations and/or timing of lightning strikes, i.e., even if data from sensors 104 (and/or sensors 107) from a single vehicle 102 would not be sufficient to identify the location and/or timing of the lightning strikes.

Additionally, in some examples, the triggering event application 124 may utilize other types of sensor data from the sensors 104 and/or sensors 107, including, e.g., vehicle operational data from vehicle operational sensors, such as acceleration data, braking data, vehicle velocity data, vehicle cornering data, etc., alone or in combination with environmental sensor data to indirectly determine whether a weather event has occurred in a particular location. For instance, the triggering event application 124 may determine that there is rain, snow, or ice in a particular location based upon slower braking, cornering, or speeds associated with vehicles 102 in the location compared to other times. Furthermore, the triggering event application 124 may utilize environmental data such as temperature data from sensors 104 (and/or sensors 107) associated with the same vehicle 102 or other vehicles 102 in the location in order to further distinguish between, e.g., a rainstorm and a snowstorm.

In any case, if a weather authority indicates that a particular weather event has occurred in a particular location at a particular time, and the triggering event application 124 determines from the combined data from the various sensors 104 and/or sensors 107 (associated with one vehicle 102 or multiple vehicles 102) that the particular weather event has not occurred at the particular location at the particular time, the triggering event application 124 may determine that the accuracy of the weather event data from the weather authority is lower than if the triggering event application 124 determines from the combined data from the various sensors 104 and/or sensors 107 (associated with one vehicle 102 or multiple vehicles 102) that the particular weather event has occurred at the particular location at the particular time.

Furthermore, in some examples, determining whether a particular weather event has occurred at a particular location (and/or a particular time) may be based upon applying a trained triggering event machine learning model 128 to the data captured by the sensors 104 and/or captured by the sensors 107.

In some examples, the triggering event machine learning model 128 may be executed on the computing system 106, while in other examples the triggering event machine learning model 128 may be executed on another computing system, separate from the computing system 106. For instance, the computing system 106 may send environmental sensor data (and/or other sensor data) to another computing system, where the trained triggering event machine learning model 128 is applied to the environmental sensor data (and/or other sensor data), and the other computing system may send a prediction or identification of a weather or other triggering event, based upon applying the trained triggering event machine learning model 128 to the environmental sensor data (and/or other sensor data), to the computing system 106. Moreover, in some examples, the triggering event machine learning model 128 may be trained by a machine learning model training application 126 executing on the computing system 106, while in other examples, the triggering event machine learning model 128 may be trained by a machine learning model training application executing on another computing system, separate from the computing system 106.

Whether the triggering event machine learning model 128 is trained on the computing system 106 or elsewhere, the triggering event machine learning model 128 may be trained by the machine learning model training application 126 using training data corresponding to historical environmental sensor data (and/or other sensor data) from historical vehicles within a threshold proximity of various locations at various times, and historical weather events confirmed to have occurred at the same locations at the various times, to predict whether a particular weather event has occurred at a particular location/time based upon new environmental sensor data (and/or other sensor data) from vehicles within a threshold proximity of that location at the time. The trained machine learning model may then be applied to the environmental sensor data (and/or other sensor data) captured by sensors 104 of the identified vehicles 102 (and/or captured by the sensors 107 associated with the mobile computing devices 105 associated with the drivers and/or passengers of the vehicles 102) at particular locations/times in order to determine, e.g., whether a given weather event has occurred at the particular location/time and/or the likelihood that the given weather event has occurred at the particular location/time.

In various aspects, the triggering event machine learning model 128 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the triggering event machine learning model 128 may comprise a library or package executed on the computing system 106 (or other computing devices not shown in FIG. 1). For example, such libraries may include the TENSORFLOW based library, the PYTORCH library, and/or the SCIKIT-LEARN Python library.

Machine learning may involve identifying and recognizing patterns in existing data (such as training a model based upon historical environmental sensor data) in order to facilitate making predictions or identification for subsequent data (such as using the machine learning model on new environmental sensor data order to determine a prediction of whether a given weather event has occurred at the particular location/time and/or the likelihood that the given weather event has occurred at the particular location/time).

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

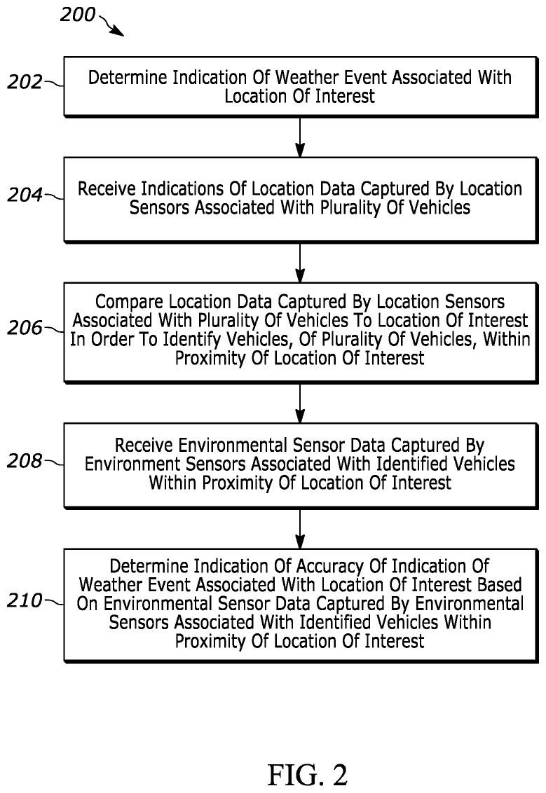

In addition, memories 122 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 122 may include instructions for carrying out any of the steps of the method 200 via an algorithm executing on the processors 120, which is described in greater detail below with respect to FIG. 2. It should be appreciated that one or more other applications may be envisioned and that are executed by the processor(s) 120. It should be appreciated that given the state of advancements of mobile computing devices, all of the processes functions and steps described herein may be present together on a mobile computing device.

### Exemplary Computer-Implemented Method for Using Autonomous & Connected Vehicles as Secondary Data Sources to Confirm Weather Data & Other Triggering Events

FIG. 2 depicts a flow diagram of an exemplary computer-implemented method 200 for using autonomous and connected vehicles as secondary data sources to confirm weather data and other triggering events, according to one embodiment. One or more steps of the method 200 may be implemented as a set of instructions stored on a computer-readable memory (e.g., memory 122) and executable on one or more processors (e.g., processor 120).

The method may begin when an indication of a weather event associated with a location of interest is determined (block 202). For instance, the location of interest may be a location associated with a damaged home or vehicle, e.g., a damaged home or vehicle for which an insurance claim for weather-related damage has been filed. In some examples, determining the indication of the weather event may include retrieving an indication of the weather event from a weather event database, such as a National Oceanic and Atmospheric Administration (NOAA) database storing indications of weather events and locations and/or times associated with each weather event. For instance, the weather event database may include an indication that a tornado, a lightning strike, a hailstorm, a rainstorm, flooding, a drought, a heat wave, etc., occurred at a particular range of geographic coordinates over a particular range of times.

Moreover, in some examples, determining the indication of the weather event may include determining a time or a range of times associated with the weather event. For instance, the weather event may have occurred at a particular date and time, or over a range of hours.

Indications of location data captured by location sensors associated with each of a plurality of vehicles may be received (block 204). In some examples, the location data may be time-stamped, i.e., indicating times at which the vehicles were at particular locations.

The location data captured by the location sensors associated with each of the plurality of vehicles may be compared (block 206) to a location of interest in order to identify one or more vehicles, of the plurality of vehicles, within a proximity of the location of interest. In some examples, identifying the vehicles within the proximity of the location of interest may include identifying vehicles associated with location data within a threshold distance of the location of interest, that is time-stamped at a time or range of times associated with the weather event.

Environmental sensor data captured by environmental sensors (or other sensors) associated with one or more of the identified vehicles may be received (block 208). For instance, the sensors may include cameras, microphones, noise level sensors, infrared or other heat sensors, light sensors (which may include solar cells), humidity sensors, wind sensors, precipitation detection sensors, temperature sensors, seismometers, gyrometers, accelerometers, magnetic sensors, lightning detection sensors, flood sensors, vibration sensors, snow depth sensors, hail detection sensors, smoke (or other gas detection) sensors, or any other sensors suitable for directly or indirectly detecting weather conditions such as an amount of rain or snow, a size of hail, lightning conditions, flood conditions, hurricane conditions, wind conditions, tornado conditions, blizzard conditions, ice storm conditions, or other natural conditions such as wildfires, earthquakes, etc.

Based upon the environmental sensor data captured by the environmental sensors associated with the one or more of the identified vehicles, an indication of an accuracy of the indication of the weather event associated with the location of interest may be determined (block 210).

In some examples, determining the indication of the accuracy of the indication of the weather event may include applying a trained machine learning model to the environmental sensor data captured by the environmental sensors associated with the identified vehicles. For instance, the machine learning model may be trained using training data including historical environmental sensor data captured by environmental sensors at locations of historical weather events, to identify weather events at a given location based upon environmental sensor data captured within a proximity of the given location. Furthermore, the machine learning model may be trained based upon times at which the historical sensor data is captured and times of the historical weather events, to identify weather events occurring at the given location at a given time or range of times based upon environmental sensor data captured within the proximity of the given location at the given time or range of times.

Additionally, in some examples, the method 200 may include triggering an insurance payout of a parametric insurance policy for the insured home, business, and/or vehicle based upon the determined accuracy of the indication of the weather event. For instance, an insurance payout may be triggered when the determined accuracy of the indication of the weather event at block 210 is greater than a threshold level of accuracy. The insurance payout amount may be predetermined in advance of the occurrence of the triggering event, and once the accuracy of the triggering event is confirmed, an automatic payment may be initiated, e.g., from the computing system 106 to a mobile computing device 105 associated with a user insured by a parametric insurance policy. As an example, a parametric insurance policy may be triggered based on a threshold number of inches of snowfall or rainfall, or based upon the occurrence of a weather event such as a tornado or hurricane. Once the accuracy of the threshold number of inches of snowfall or rainfall is confirmed, and/or once the accuracy of the occurrence of the tornado, hurricane, etc., is confirmed, the automatic payment in the predetermined amount may be initiated.

Moreover, in some examples, various steps of the method 200 may be used to generate an insurance quote, generate or handle an insurance claim, determine an amount of damage to vehicle or home, determine a repair or replacement cost, etc. That is, confirming, with a threshold accuracy, that a given weather event or other triggering event has occurred within the immediate vicinity of an insured home, business, and/or vehicle may be used to generate an insurance claim based upon the occurrence of the weather event or other triggering event.

Similarly, confirming, with a threshold accuracy, that a given weather event or other triggering event has occurred within the immediate vicinity of an insured home, business, and/or vehicle may be used, along with other data, to determine an amount of damage that has been done to the insured home, business, and/or vehicle. Moreover, in some cases, the sensor data that is used to confirm that the weather event or other triggering event has occurred within the immediate vicinity of an insured home may also be analyzed to determine the amount of damage that has been done to the insured home, business, and/or vehicle, e.g., based upon images, sound recordings, or other sensor data captured in the immediate vicinity of the insured home, business, and/or vehicle at the time of the weather or other triggering event.

In a similar manner, confirming, with a threshold accuracy, that a given weather event or other triggering event has occurred within the immediate vicinity of an insured home, business, and/or vehicle may be used, along with other data, to determine a repair or replacement cost for any damage done to the insured home, business, and/or vehicle. Moreover, in some cases, the sensor data that is used to confirm that the weather event or other triggering event has occurred within the immediate vicinity of an insured home may also be analyzed to determine a repair or replacement cost for any damage done to the insured home, business, and/or vehicle, e.g., based upon images, sound recordings, or other sensor data captured in the immediate vicinity of the insured home, business, and/or vehicle at the time of the weather or other triggering event.

### Exemplary Computing System for Using Autonomous & Connected Vehicles as Secondary Data Sources to Confirm Weather Data & Other Triggering Events

FIG. 3 depicts an exemplary computing system 106 in which the techniques described herein may be implemented, according to one embodiment. The computing system 106 of FIG. 3 may include a computing device in the form of a computer 310. Components of the computer 310 may include, but are not limited to, a processing unit 320 (e.g., corresponding to the processor 120 of FIG. 1), a system memory 330 (e.g., corresponding to the memory 122 of FIG. 1), and a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 may include a variety of computer-readable media. Computer-readable media may be any available media that can be accessed by computer 310 and may include both volatile and nonvolatile media, and both removable and non-removable media. By way of example, and not limitation, computer-readable media may comprise computer storage media and communication media.

Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 330 may include computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 3 illustrates operating system 334, application programs 335 (e.g., corresponding to the triggering event application 124 of FIG. 1), other program modules 336, and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 3 provide storage of computer-readable instructions, data structures, program modules and other data for the computer 310. In FIG. 3, for example, hard disk drive 341 is illustrated as storing operating system 344, application programs 345, other program modules 346, and program data 347. Note that these components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a mobile computing device, personal computer, a server, a router, a network PC, a peer device or other common network node, and may include many or all of the elements described above relative to the computer 310, although only a memory storage device 381 has been illustrated in FIG. 3. The logical connections depicted in FIG. 3 include a local area network (LAN) 371 and a wide area network (WAN) 373 (e.g., either or both of which may correspond to the network 108 of FIG. 1), but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 may include a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 3 illustrates remote application programs 385 as residing on memory device 381.

The techniques for using autonomous and connected vehicles as secondary data sources to confirm weather data and other triggering events described above may be implemented in part or in their entirety within a computing system such as the computing system 106 illustrated in FIG. 3. In some such embodiments, the LAN 371 or the WAN 373 may be omitted. Application programs 335 and 345 may include a software application (e.g., a web-browser application) that is included in a user interface, for example.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for using autonomous and connected vehicles as secondary data sources to confirm weather data and other triggering events. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for using autonomous and connected vehicles as secondary data sources to confirm weather data and other triggering events, comprising:
determining, by one or more processors, an indication of a weather event associated with a location of interest;
receiving, by the one or more processors, indications of location data captured by location sensors associated with each of a plurality of vehicles;
comparing, by the one or more processors, the location data captured by the location sensors associated with each of the plurality of vehicles to a location of interest in order to identify one or more vehicles, of the plurality of vehicles, within a proximity of the location of interest;
receiving, by the one or more processors, environmental sensor data captured by environmental sensors associated with one or more of the identified vehicles; and
determining, by the one or more processors, based upon the environmental sensor data captured by the environmental sensors associated with the one or more of the identified vehicles, an indication of an accuracy of the indication of the weather event associated with the location of interest.

2. The computer-implemented method of claim 1, wherein the location of interest is a location associated with a damaged home or vehicle.

3. The computer-implemented method of claim 1, wherein determining the indication of the weather event includes retrieving the indication of the weather event from a weather event database.

4. The computer-implemented method of claim 1, wherein determining the indication of the weather event includes determining a time or a range of times associated with the weather event, and wherein identifying the one or more vehicles, of the plurality of vehicles, within a proximity of the location of interest includes identifying the one or more vehicles, of the plurality of vehicles, that were within the proximity of the location of interest at the time or range of times associated with the weather event.

5. The computer-implemented method of claim 1, wherein determining the indication of the accuracy of the indication of the weather event associated with the location of interest based upon the environmental sensor data captured by the environmental sensors associated with the one or more of the identified vehicles includes applying a trained machine learning model to the environmental sensor data captured by the environmental sensors associated with the one or more of the identified vehicles.

6. The computer-implemented method of claim 5, wherein the machine learning model is trained using training data including historical environmental sensor data captured by environmental sensors at locations of historical weather events, to identify weather events at a given location based upon environmental sensor data captured within a proximity of the given location.

7. The computer-implemented method of claim 6, wherein the machine learning model is further trained using times at which the historical sensor data is captured and times of the historical weather events, to identify weather events occurring at the given location at a given time or range of times based upon environmental sensor data captured within the proximity of the given location at the given time or range of times.

8. A computer system for using autonomous and connected vehicles as secondary data sources to confirm weather data and other triggering events, comprising one or more processors and a memory storing computer-executable instructions that, when executed by the one or more processors, cause the one or more processors to:
determine an indication of a weather event associated with a location of interest;
receive indications of location data captured by location sensors associated with each of a plurality of vehicles;
compare the location data captured by the location sensors associated with each of the plurality of vehicles to a location of interest in order to identify one or more vehicles, of the plurality of vehicles, within a proximity of the location of interest;
receive environmental sensor data captured by environmental sensors associated with one or more of the identified vehicles; and
determine, based upon the environmental sensor data captured by the environmental sensors associated with the one or more of the identified vehicles, an indication of an accuracy of the indication of the weather event associated with the location of interest.

9. The system of claim 8, wherein the location of interest is a location associated with a damaged home or vehicle.

10. The system of claim 8, wherein the instructions causing the one or more processors to determine the indication of the weather event include instructions that cause the one or more processors to retrieve the indication of the weather event from a weather event database.

11. The system of claim 8, wherein the instructions causing the one or more processors to determine the indication of the weather event include instructions that cause the one or more processors to determine a time or a range of times associated with the weather event, and wherein the instructions causing the one or more processors to identify the one or more vehicles, of the plurality of vehicles, within a proximity of the location of interest includes instructions that cause the one or more processors to identify the one or more vehicles, of the plurality of vehicles, that were within the proximity of the location of interest at the time or range of times associated with the weather event.

12. The system of claim 8, wherein the instructions causing the one or more processors to determine the indication of the accuracy of the indication of the weather event associated with the location of interest based upon the environmental sensor data captured by the environmental sensors associated with the one or more of the identified vehicles include instructions that cause the one or more processors to apply a trained machine learning model to the environmental sensors associated with the one or more of the identified vehicles.

13. The system of claim 12, wherein the machine learning model is trained using training data including historical environmental sensor data captured by environmental sensors at locations of historical weather events, to identify weather events at a given location based upon environmental sensor data captured within a proximity of the given location.

14. The system of claim 13, wherein the machine learning model is further trained using times at which the historical sensor data is captured and times of the historical weather events, to identify weather events occurring at the given location at a given time or range of times based upon environmental sensor data captured within the proximity of the given location at the given time or range of times.

15. A non-transitory computer-readable storage medium storing computer-readable instructions for using autonomous and connected vehicles as secondary data sources to confirm weather data and other triggering events, wherein the computer-readable instructions, when executed by one or more processors, cause the one or more processors to:
determine an indication of a weather event associated with a location of interest;
receive indications of location data captured by location sensors associated with each of a plurality of vehicles;
compare the location data captured by the location sensors associated with each of the plurality of vehicles to a location of interest in order to identify one or more vehicles, of the plurality of vehicles, within a proximity of the location of interest;
receive environmental sensor data captured by environmental sensors associated with one or more of the identified vehicles; and
determine, based upon the environmental sensor data captured by the environmental sensors associated with the one or more of the identified vehicles, an indication of an accuracy of the indication of the weather event associated with the location of interest.

16. The non-transitory computer-readable storage medium of claim 15, wherein the location of interest is a location associated with a damaged home or vehicle.

17. The non-transitory computer-readable storage medium of claim 15, wherein the instructions causing the one or more processors to determine the indication of the weather event include instructions that cause the one or more processors to retrieve the indication of the weather event from a weather event database.

18. The non-transitory computer-readable storage medium of claim 15, wherein the instructions causing the one or more processors to determine the indication of the weather event include instructions that cause the one or more processors to determine a time or a range of times associated with the weather event, and wherein the instructions causing the one or more processors to identify the one or more vehicles, of the plurality of vehicles, within a proximity of the location of interest includes instructions that cause the one or more processors to identify the one or more vehicles, of the plurality of vehicles, that were within the proximity of the location of interest at the time or range of times associated with the weather event.

19. The non-transitory computer-readable storage medium of claim 15, wherein the instructions causing the one or more processors to determine the indication of the accuracy of the indication of the weather event associated with the location of interest based upon the environmental sensor data captured by the environmental sensors associated with the one or more of the identified vehicles include instructions that cause the one or more processors to apply a trained machine learning model to the environmental sensors associated with the one or more of the identified vehicles.

20. The non-transitory computer-readable storage medium of claim 19, wherein the machine learning model is trained using training data including historical environmental sensor data captured by environmental sensors at locations of historical weather events, to identify weather events at a given location based upon environmental sensor data captured within a proximity of the given location.
